(19) United States
(12) Patent Application Publication
(10) Pub. No.: US 2017/0076009 A1
(43) Pub. Date: Mar. 16, 2017

(54) SYSTEMS AND METHODS FOR PRESENTING EVENTS

(71) Applicants: Kyle Kleinbart, New York, NY (US); Ariana Loizias, Short Hills, NJ (US)

(72) Inventors: Kyle Kleinbart, New York, NY (US); Ariana Loizias, Short Hills, NJ (US)

(21) Appl. No.: 14/649,916

(22) PCT Filed: Jun. 4, 2015
(86) PCT No.: PCT/US15/34308

§ 371 Date: Jun. 5, 2015

Related U.S. Application Data
(60) Provisional application No. 62/007,494, filed on Jun. 4, 2014.

(51) Int. Cl. G06F 17/30

(52) U.S. Cl. CPC G06F 17/30991; G06F 17/3097

(57) ABSTRACT

Systems and Methods are disclosed. One or more processors access, manage, modify, transmit, integrate, consolidate, reduce, organize, enhance, take action on, or a combination thereof, at least one data and data actions associated with a user. A presentation of data is provided that includes the data. The presentation may include a perpetually changing representation of data in accordance with time that provide visual spatial indication of data presented perpetually in accordance with the perpetual changing of Time. First electronic data event information representing a sending or receiving of data associated with at least one of a plurality of users is received and at least one of the data is organized and least some of the data actions are accessible. Data could be organized according to values of relevancy that are universally distinct and have continued importance. The presentation of data is modified based at least on one of the managing, modifying, transmitting, integrating, consolidating, reducing, organizing, enhancing, acting on, or a combination thereof, and is provided to the user.

### RELATED APPLICATION

This application is based on and claims priority to U.S. Provisional Application Ser. No. 62/007,494, filed on Jun. 4, 2014 and entitled “SYSTEMS AND METHODS FOR PRESENTING EVENTS,” the entire contents of which are hereby incorporated by reference.

### BACKGROUND

Field

The present application relates, generally, to data transmission and, more particular, to accessing, managing, modifying, transmitting, integrating, consolidating, reducing, organizing, enhancing, and taking action on data in connection with personal, social, and professional efficiency.

Description of the Related Art

Presently, many people have data distributed across a number of services. Messaging services, note taking services, task management services, calendar services, file management services, shopping services, financial services, and bookmarking services, for example, are used by individuals, groups, and organizations to access, manage, and transmit data. This dispersion of data across services often produces redundancies or incompleteness. With the variety of data types, too many services are needed to access, manage, and transmit such data, resulting in disorganization and inefficiency.

Additionally, filtering data according to relevance within the context of a particular service, or a certain type of service is often inadequate in aiding people to determine what data to view and when to view such data at least because data is dispersed across services.

Moreover, with one's data dispersed across services, there is no sufficient way to search through all of one's data, and no effective way to transmit all outbound data.

Further, existing data categorization does not provide perspective about the relevancy of data to people over time because the existing categories are not indicators of consistent importance.

Currently, filing systems require that people know the exact layering of folders or include keywords for locating data. These existing means of organizing data have been applied independently, resulting in disorganization and inefficiency.

In addition, data of all varieties pertains to a time when the data was recorded, and some data pertains to a scheduled time, though data is not currently represented in accordance with the live movement of Time.

Furthermore, providing targeted advertising or recommendations to users based on the tracking of interests across search history, browsing history, data exchanged within existing services, or through other means, is unsuitable for capturing the changing degree of significance for an interest of a person.

### SUMMARY

The present application provides systems and methods for access, management, modification, transmission, integration, consolidation, reduction, action, organization, enhancement, and presentation associated with data transmission. This is provided, at least in part, by the perpetual presentation of data moving in accordance with a flow of Time, data filtering and search, data filing, and categorizing data. This results in an integration of data that is more organized, efficient, and that can be enhanced.

### BRIEF DESCRIPTION OF THE DRAWINGS

For the purpose of illustrating the invention, there is shown in the drawings several forms which are presently preferred, it being understood, however, that the invention is not limited to the precise arrangements and instrumentalities shown. The features and advantages of the present invention will become apparent from the following description of the invention that refers to the accompanying drawings, in which:

FIG. 1 illustrates an example hardware arrangement, in accordance with an embodiment of the present application;

FIG. 2 illustrates functional elements, of which one or more may be configured in a computing device, in accordance with an embodiment;

### DESCRIPTION OF THE EMBODIMENTS

In an embodiment, a data management network is disclosed that supports a network of people who are connected, for example, to one or more data, and who have tools necessary to access, manage, modify, transmit, integrate, consolidate, reduce, organize, enhance, and take action on data. A data management network in accordance with the present application substantially increases effectiveness of data management over known systems and methods. As used herein, the term, “data,” refers, generally to the quantities, characters, or symbols on which operations are performed, being stored and transmitted. Data may appear to a user in a form, for example, that could include Text, Numbers, Symbols, Code, Multimedia, Animations, Emoticons, Icons, Images, Videos, Audios, Documents, Webpages, Links, Reservations, Invitations, Receipts, Reviews, Promotions, Instructions, Operations, Temporary Content, APIs, Maps, Locations, Contacts, Persons, Tags, Hashtags, Labels, Time Parameters, Date Parameters, and Communication oriented in ways, for example, that could include Oneself to Oneself, Person to Person, One to Many, Many to One, Many to Many, Software to Software, Software to Hardware, Hardware to Software, Machine to Machine, Machine to Person, Person to Machine. Also as used herein, the term, “data-event” relates to a transmission of data, and may represent any way that data are sent and received. For example, data may be transmitted via an API, via a known protocol, via a proprietary protocol, via user data entry (including by selections), and via analog sources. Data-events may trigger correlating processes by a computer. Additionally used herein, the term, “data-action” relates to acting on or in accordance with data, and may represent any way that data are managed. For example, data may be viewed, created, edited, deleted, shared, or the like, or a combination thereof. Data-actions may trigger correlating processes by a computer. A data management network could be provided in accordance with the teachings herein and may be implemented in an Internet web-based environment that provides users with tools that may be necessary to access, manage, modify, transmit, integrate, consolidate, reduce, organize, enhance, and take action on their data. For example, a web-based environment could support an interactive data transmission portal, writing tools, viewing tools, search mechanisms, filtering mechanisms, categorization mechanisms, filing mechanisms, time-related functionality, calendar-related functionality, and map-related functionality.

The tools disclosed herein may be provided to utilize real-time technologies to improve user interaction. The interactive data transmission portal, for example, represents a technological breakthrough in data access and transmission.

In an embodiment, data may be transmitted in any variety and combination of orientations, and in any form. For example, data may be transmitted Oneself to Oneself, Person to Person, One to Many, Many to One, Many to Many, Software to Software, Software to Hardware, Hardware to Software, Machine to Machine, Machine to Person, or Person to Machine.

The present application may receive incoming data-events from, and send outgoing data-events through, any number of APIs. The data sent to and from such APIs, for example, may be aggregated together such that all data is directly accessible.

In connection with a server side API, various server side API calls may be involved, for example, via Internet web services, which may be consumed either in various open source platforms, such as NODE.JS, or in proprietary platforms.

Alternatively, in an embodiment, the present application may provide services without a need to support or otherwise provide external APIs. Accordingly, in an embodiment, the present application may exist independent of any additional service integrations, such that the present application and tools described herein, for example the consolidation of data types, may be utilized for data created solely within a data management network.

In an embodiment, the tools disclosed herein may utilize a method for connecting accounts or importing data from services, or a combination thereof. Data from such services may be of various types that could include, for example, Messages, Notes, Tasks, Calendars, Files, Media, Links, Financials, News Subscriptions, Reservations, Receipts, Contacts, Locations, Businesses, Reviews, Internet-connected Things, and Time.

In an embodiment, an integration of services could provide a centralized portal for transmitting data. A service with access to other services, for example, may transmit data outbound to many services.

In an embodiment, data may be managed. Data may, for example, be viewed, created, edited, deleted, shared, or received, or a combination thereof, by one or more persons or operations or machines, or combination thereof.

In an embodiment, people may manage their own data. Managing one's own contact data, for example, may ensure that the data remain relevant.

In an embodiment, people may assign privileges to data. Assigning privileges to data may ensure, for example, that data access, transmission, and modification is preferential.

In an embodiment, a person's data could be aggregated into organized sets of data that could be considered related. Connecting accounts or importing data from other services, for example, may include contact-related data that could be collected into a unified profile for a person.

In an embodiment, organizing data into consolidations could be automated. Data may be aggregated by computing processes, for example, that may include meta-data analysis, semantic analysis, and algorithms.

In an embodiment, organizing data into consolidations could be a manual process. Data may be organized by user-selection, for example.

Additionally, organizing data into consolidations could be a combination of automated and manual processes. For example, data may be aggregated by computing processes that a user could override.

In an embodiment, functionality may be provided to search through or filter, or combination thereof, the data from one or more services. Data may be reduced by one or more filters that may include, for example, Data Type, Service Category, Service, Account, Time Period, Person, Group, Team, Organization, Location, Proximity, Rating, Ranking, Recommendation, Entity Type, Category, Keyword, Style, Taste, Price, Relationship, Trending Level, Emotion, Value, Quality, Quantity, Comparison, Size, Relevance, Importance, Archive, Deleted, Unread, Frequency, Interest, Rate of Change.

In an embodiment, applying filtering characteristics to data could be automated. Data may be characterized by computing processes that may include, for example, meta-data analysis, semantic analysis, and algorithms.

In an embodiment, applying filtering characteristics to data could be a manual process. Data may be characterized by user-selection, for example.

Additionally, applying filtering characteristics to data could be a combination of automated and manual processes. For example, data may be characterized by computing processes that a user could override.

In an embodiment, the present application could record the history of search entries. Also, functionality could be provided for enhanced entries. Recommending search queries, for example, may include data collection and algorithmic processes.

In an embodiment, one or more particular search entries could be readily available to more efficiently access data. A search entry may be saved, for example, by user-selection.

The tools disclosed herein may be provided to utilize novel methods of categorization. The categorization mechanisms, for example, represent a technological breakthrough in data contextualization.

In an embodiment, data could be organized according to relevancy. Data may be labeled, for example, by values that could include “Questions”, “Information”, “Tasks, and “Events”, each of which is universally distinct and has continued importance.

In an embodiment, organizing data by relevancy could be automated. Data may be organized by computing processes, for example, that may include meta-data analysis, semantic analysis, and algorithms.

In an embodiment, organizing data by relevancy could be a manual process. Data may be organized by user-selection, for example.

Additionally, organizing data by relevancy could be a combination of automated and manual processes. For example, data may be organized by computing processes that a user could override.

The tools disclosed herein may utilize a combination of nested filing and keywords to improve data organization. Utilizing nested keywords to organize data of any kind, for example, represents a technological breakthrough in data organization.

In an embodiment, data could be organized by keywords, a nesting of keywords, or a combination thereof. Parent keywords, for example, may exist without children keywords, and may exist in tandem with parent keywords that have children keywords nested within them.

In an embodiment, data that is organized with a nesting of keywords could be accessible from a child keyword. Viewing data associated with a child keyword may include, for example, the data associated with this nested child keyword.

In an embodiment, data that is organized with a nesting of keywords could be accessible from the parent keyword. Viewing data associated with a parent keyword may include, for example, the data associated with one or more child keywords that are layered within this parent keyword.

In an embodiment, child keywords may be accessible from a parent keyword. Accessing a parent keyword may provide, for example, access to child keywords.

In an embodiment, navigation could be provided for accessing keywords. Descending and ancestral navigation may provide, for example, traversal of nested hierarchies.

In an embodiment, keywords, parent keywords, and child keywords, could all be immediately accessible. When selecting a keyword, for example, all keywords may be presented.

In accordance with the teachings herein, in an embodiment, searching for or filtering through data could include the ability to filter by keywords and nested keywords. For example, data may be narrowed by one or more keywords, or one or more nested keywords, or a combination thereof.

In an embodiment, data could be centrally organized. With all keywords sharing a centralized top layer, for example, accessing data may be more efficient.

In an embodiment, keywords and nested keywords could be recommended. Computing processes that may include semantic analysis and algorithms, for example, may provide recommended keywords and nested keywords.

Additionally, in accordance with the teachings herein, keywords and nested keywords could be recommended for filtering search. Computing processes that may include semantic analysis and algorithms, for example, may provide recommended keywords and nested keywords for narrowing search results.

In an embodiment, data organized by various keywords could be accessible in combination. Data associated with different keywords, for example, may be viewable together.

The tools disclosed herein may utilize a combination of real-time technologies and a novel method of continuous data mapping. The viewing tools, for example, represent a technological breakthrough for presenting data.

In an embodiment, the tools disclosed herein may utilize a method for presenting data in accordance with a flow of time. Data-events, for example, may be mapped continuously in a time-based presentation.

In an embodiment, views of data may themselves be moving in accordance with a perpetual flow of Time. The relationship between data and the natural movement of Time, for example, may thus be perpetually represented, and the time in between data-events may also be represented.

The tools disclosed herein may be enhanced by additional data and tools. The interests of a person may change over time, such that analysis of a person's data could be applied to produce relevant suggestions for enhancements.

In addition, given the present application, an analysis of people's data in a person's network could be applied to produce collectively influential suggestions for enhancements. An analysis of a person's contacts' interests, for example, could provide insight into potential changes of interest for the person.

In an embodiment, data could be analyzed. With an analysis of a person's data determining a personal interest in exploring restaurants, for example, recommendations of new restaurants may then be provided to the person.

Additionally, in accordance with the teachings herein, data could be organized in accordance with time, and as such an analysis of a person's time-related data could be applied to produce relevant suggestions for enhancements. With an analysis of a person's time-related data determining an availability, for example, recommendations of activities may then be provided to the person.

Moreover, in accordance with the teachings herein, an analysis of a person's data may be combined with an analysis of a person's time-related data and could be applied to produce relevant suggestions for enhancements. With an analysis of a person's data determining a personal interest in exploring restaurants, combined with an analysis of a person's time-related data determining an availability, for example, recommendations of new restaurants for the particular availability may then be provided to the person.

Further, in accordance with the teachings herein, data could be aggregated from one or more services, and as such an analysis of a person's data from one or more services could be applied to produce relevant suggestions for enhancements. With an analysis of a person's service-related data determining a preference for a particular cuisine, for example, recommendations of dining experiences related to the particular cuisine may then be provided to the person.

Furthermore, an integration of data could provide opportunities to expand upon data. Involving gaming mechanics with accessing, managing, or transmitting data, for example, may have added social significance.

In an embodiment, rewards could be provided. An accomplishments economy, for example, may reward people for transmitting their accomplishments.

In an embodiment, digital currency could be provided. In exchange for one or more persons transmitting data, for example, other people may invest digital currency in the exchange, and people who have not invested may determine whether the persons transmitting and the people investing receive a return of digital currency.

In an embodiment, tangible rewards could be exchanged. In exchange for one or more persons transmitting data, for example, other people may invest in the exchange, and businesses may sponsor the data transmission and provide the persons transmitting and the people investing with goods, services, or discounts in return.

The tools disclosed herein may involve artificial intelligence. With access to peoples' data, computing processes could converse with people regarding their data.

In an embodiment, data could be presented in conversation form. A person may access data by transmitting data to a System in the form of a question, for example, and the System may present data to the person in the form of an answer.

In an embodiment, a person could conduct text-based conversations with a System. Semantic analysis, for example, may provide Systems the ability to respond with semantically structured text.

In accordance with the teachings herein, a person could conduct text-based conversations with a service or System of integrated services. A person may retrieve data, for example, by conversing with a service or System.

Further, in accordance with the teachings herein, a person could instruct a service or System of integrated services. A person may make reservations and purchases, for example, by instructing a System of integrated services.

Furthermore, in accordance with the teachings herein, a person could instruct a service or System of integrated services through text-based conversation. A person could direct the System to make edits and additions, such as to the person's schedule, by conversing with a System of integrated services.

The teachings herein may also be characterized as a networked operating system. Through an extensive SDK (Software Developers Kit), consisting of API's, developers are able to incorporate other tools (programs) or items (materials) that help individuals or organizations access, manage, modify, transmit, integrate, consolidate, reduce, organize, enhance, present, or take action on data, or a combination thereof. Third-party tools may be offered for purchase through, for example, a digital store.

The data management network is preferably web-based, but may also extend to mobile platforms through mobile-formatted sites and native mobile applications. Additionally, the teachings herein may also be provided as a desktop application.

In connection with mobile platforms, the present application may serve as the default provider of services. The ANDROID platform, for example, provides people the option of choosing a default short messaging service (SMS) application, and as such the present application could be selected to serve as the default provider of short service messaging.

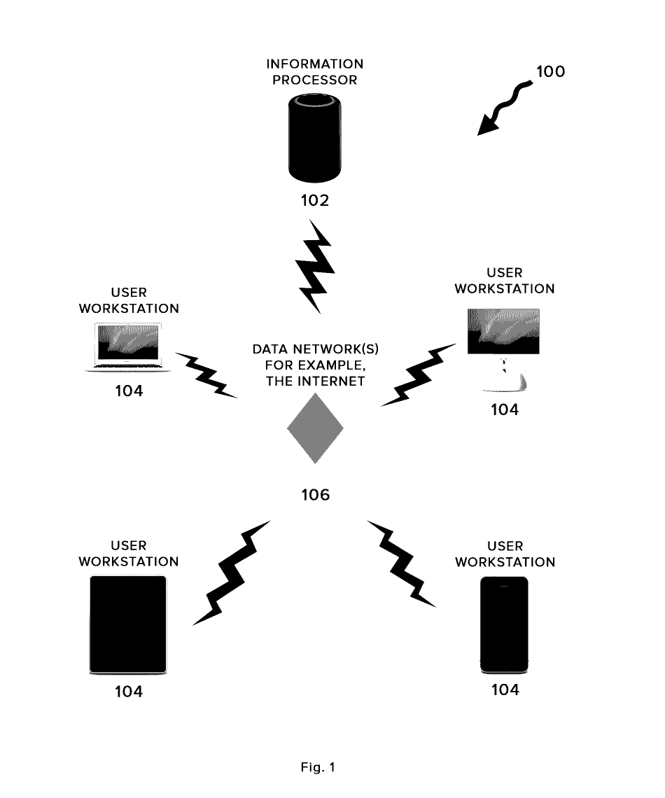

Referring now to the drawing figures, in which like reference numerals represent like elements, FIG. 1 illustrates an example hardware arrangement in accordance with an embodiment of the present application. Referred to generally, herein, as system 100, the arrangement provides for monitoring and notification services in accordance with the teachings herein. System 100 includes at least one information processor 102 (configured to operate as an Internet web server and/or database file server) that is programmed and configured to access data management network 106 and communicate with computing device(s) 104. Computing devices 104 may be personal computers, and may further be mobile devices, such as one or more of the GOOGLE ANDROID, APPLE iOS, WINDOWS MOBILE operating systems, and may include smartphone devices, tablet computing devices, augmented reality devices, virtual reality devices, holographic devices, or other mobile portable devices. Computing devices 104 and information processor(s) 102 may communicate via a known communications protocol, such as Transmission Control Protocol/Internet Protocol “TCP/IP.” Information processor 102 and computing device(s) 104 preferably are provided with or have access to all databases necessary to support the present application.

Data management network 106 is preferably a global public communication network such as the Internet, but can also be a wide area network (WAN), local area network (LAN), an intranet or other network that enables computing devices and peripheral devices to communicate.

In a preferred embodiment, information processor(s) 102 and computing devices 104 may be equipped with web browser software, such as MOZILLA FIREFOX, GOOGLE CHROME, APPLE SAFARI, MICROSOFT INTERNET EXPLORER, or the like. Information processor 102 and computing devices 104 are coupled to data management network 106 using any known data networking technology.

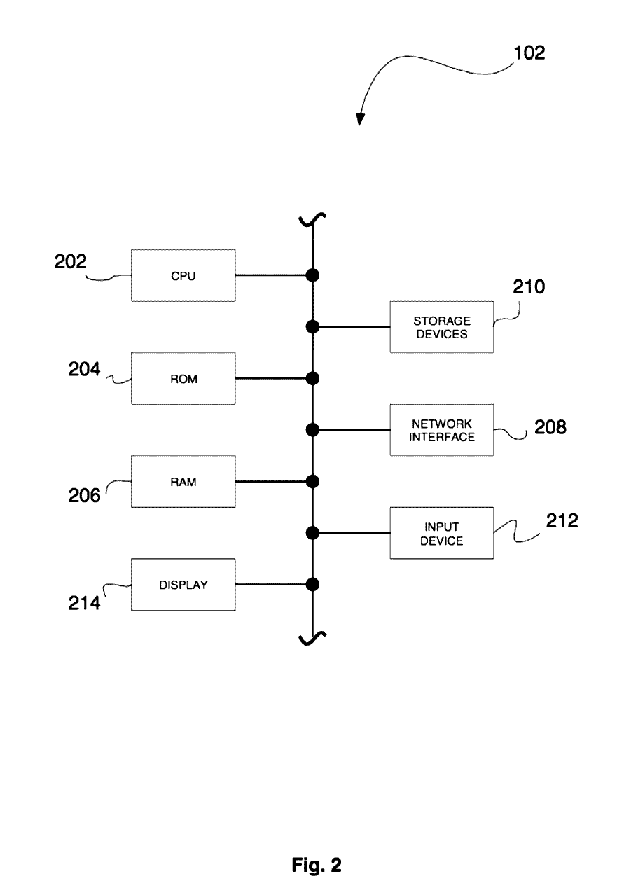

FIG. 2 illustrates functional elements, of which one or more may be configured in an example information processor 102 and/or computing device 104. The functional elements shown in FIG. 2 include one or more central processing units (CPU) 202 used to execute software code and control operations. Other elements shown in FIG. 2 include read-only memory (ROM) 204, random access memory (RAM) 206, one or more network interfaces 208 to transmit and receive data-events to and from other computing devices across a data network, storage devices 210 such as a hard disk drive, removable disk drive, server disk drive and the like, for storing program code databases and application data-events, one or more input devices 212 such as a keyboard, mouse, track ball, headset, microphone and the like, and a display 214.

The various components illustrated in FIG. 2 need not be physically contained within a single device chassis or even located in a single location. For example, storage device 210 may be located at a site that is remote from the remaining elements of information processor 102, and may even be connected to CPU 202 across data management network 106 via network interface 208. Information processor 102 and/or computing device 104 may include a memory equipped with sufficient storage, such as to provide or access the necessary databases and services communicating computer language programs. Information processor 102 and/or computing device 104 are arranged with components, for example, those shown in FIG. 2, suitable for the expected operating environment. The CPU(s) 202, network interface(s) 208 and memory and storage devices are selected to ensure that capacities are arranged to accommodate utilization.

The nature of the present application is such that one skilled in the art of writing computer executable code (i.e., software) can implement the functions described herein using one or more of a combination of popular computer programming languages and developing environments that may include, but are not limited to, C, C++, NODE.JS, PHP, DJANGO, RUBY ON RAILS, MySQL, NoSQL, JAVA, JAVASCRIPT, CANVAS, JQUERY, HTML, XML, LESS, and CSS.

Although the present application is described by way of example herein and in terms of a web-based system using web browsers and a web site server (e.g., information processor 102), system 100 is not limited to such a configuration. It is contemplated that system 100 is arranged such that information processor 102 and/or computing devices 104 communicate with and output data-events using any known method of data transmission, for example, using a non-Internet browser WINDOWS viewer coupled with a local area network protocol such as the Internet Packet Exchange (IPX), dial-up, third-party, private network or a value added network (VAN). Moreover, information processor 102 and/or computing devices 104 may communicate via an application developed to run on mobile operating systems, for example, iOS or ANDROID. Furthermore, information processor 102 and/or computing devices 104 may communicate via an application developed to run on augmented or virtual reality operating systems, for example, MAGIC LEAP SDK or GOOGLE GLASS OS or WINDOWS 10 or OCULUS SDK.

It is further contemplated that any suitable operating system can be used on information processor 102 and/or computing device 104, for example, MAC OS, WINDOWS, UNIX, LINUX, ANDROID, IOS, CHROMIUM, and any other suitable operating system.

In an embodiment, the network functions on many if not all scales by being decentralized. In an embodiment, people could create a personal data management network for individual or collaborative use, a combination thereof, or a full-scale data management network for use in organizations such as corporations or universities. Private networks provided by the teachings herein may be provided on a central server for SaaS functionality (i.e. server is provided at a remote service bureau data center) or, alternatively, may be on a server appliance in an enterprise. In yet another embodiment, networks may be integrated through a licensed offering operating in existing organizations, such as via one or more firewall-protected intranets. The latter two enterprise offerings may be managed by one or more remotely provided support teams, an organization's internal IT department, or a combination thereof.

Additionally, information processor 102 advantageously may operate as a “learning system.” For example, recommendation values are periodically updated as a function of information processor 102 employing one or more algorithms. For example, a person may consider an upscale restaurant the highest preference, and a new restaurant to be the second highest preference. Information processor 102 may be programmed and configured to determine such preferential interests automatically and initially, or may learn such preferences over time.

### DETAILED DESCRIPTION OF THE INVENTION

In an embodiment, a data management portal is provided that is effectively an aggregation of any kinds of data. An ability to access, manage, modify, transmit, integrate, consolidate, reduce, organize, enhance, and/or take action on existing and future data transmitted through different methods and/or services is provided via a synchronization of various data types and APIs (Application Programming Interface), which may utilize encryption, for example, SSL Encryption (Secure Sockets Layer) and/or TLS Encryption (Transport Layer Security) or the like. Such kinds of data may include data that relates to the Internet, Desktops, Tablets, Mobile Devices, Holograms, Projections, Display-based Devices, Electronics, Mathematics, Analytics, Calendars, Scheduling, Communication, Planning, Science, Medicine, Farming, Health, Fitness, Athletics, Organizations, Organizational, Report-based, Time-based, Time-relevant, Household, Appliances, Inventory, Shipping, Retail, Shopping, Sales, Reservations, Promotions, Ticketing, Receipts, Payments, Finance, Travel, Hotels, Establishments, Accommodations, Transportation, Energy, Humanitarianism, Philanthropy, Esotericism, Spirituality, Psychology, Philosophy, Art, Music, Design, Fashion, Culture, Cuisine, Luxury, Literature, Writings, Publishing, Blogging, History, Education, Information, Social, Personal, Research, Business, Development, Construction, Production, Management, Entertainment, Film, Television, News, Media, Government, Politics, Regions, Location, Cartography, Topography, Networking, Social, Gaming, Electronics, or the like, and in any combination thereof. Such data may exist in any type, for example, Messages, Notes, Tasks, Calendars, Files, Media, Links, Financials, News Subscriptions, Purchases, Contacts, Locations, Businesses, Reviews, Internet-connected Things, Time, or the like, and in any combination thereof. Such data may be accessed through any protocol, format, service, client, or any combination thereof. Such data may be transmitted in any orientation, for example, originating or applied to Oneself to Oneself, Person to Person, One to Many, Many to One, Many to Many, Software to Software, Software to Hardware, Hardware to Software, Machine to Machine, Machine to Person, Person to Machine, or the like, and in any combination thereof.

Moreover, data related to any kind, existing in any form, that are accessed through protocols, formats, service APIs, or client APIs are preferably presented to whom or what the data originated and/or applies. Such data-events may be provided and/or maintained in a client-side environment and/or a server-side environment. Such an aggregation of data may be accessed, managed, modified, transmitted, integrated, consolidated, reduced, organized, enhanced, and/or acted on.

Further, data that is hosted, for example, on third-party servers may be accessible in response to security credentials received from a user. For example, once a user is authenticated, use of a specific service's API or set of API's or other means of access to data enables the collecting of data, in accordance with the teachings herein.

In an embodiment, a consolidation of multiple data types is supported by the ordering of timestamp data to present the variety of data in accordance with a unified key-value pair, such that a person may access the variety of data from a single portal.

In an embodiment, consolidation of single data types is supported through automation by way of connecting accounts with services via one or more APIs through the utilization of authentication tokens, or keys, or the like, or in a combination thereof, or through the manual inputting of data. Consolidating contact-related data from multiple services, for example, may be utilized for aggregation into one or more profiles.

In an embodiment, managing data is supported by viewing, creating, editing, deleting, sharing, or the like, or a combination thereof, by algorithmically automating or manually applying one or more data-actions. For example, applying a data-action, such as inputting an edit of data, provides for data management.

In an embodiment, assigning privileges to data is supported by attributing meta-data variable assignments to data that is personal, collaborative, shared, or the like, or a combination thereof. Assigning privileges to data, for example, read, write, edit, and invite, provides that data access, transmission, and modification is preferential.

In an embodiment, filtering is supported by algorithmically automating or manually selecting a filtering qualification, paired with an analysis of meta-data relating data to the selected filter, determining value matches between the filter and the data, that then provide the matching data in accordance with the applied filter. Filtering by “service”, for example, reduces the presentation of data to presenting data that derives from the selected services, providing more direct access to certain data.

In an embodiment, combining multiple filters is supported by algorithmically automating or manually selecting multiple filtering qualifications, paired with an analysis of meta-data relating data to the selected filters, determining value matches between the filters and the data, that then provide the matching data in accordance with the applied filters. Filtering by “service” and “data type”, for example, reduces the presentation of data to presenting data that relates to the selected types of data and also derives from the selected services, providing more direct access to certain data.

In an embodiment, searching data is supported by querying one or more data sets to determine value matches between the search entries and the data, whereby the presentation of data may be reduced by one or more searches. Conducting a search with an entry of “patents that search”, for example, reduces the presentation of data to presenting data that relates to the words “patents” and “search”.

In an embodiment, searching and filtering data in combination is supported by algorithmically automating or manually selecting multiple filtering qualifications, paired with an analysis of meta-data relating data to the selected filters, determining value matches between the filters and the data, querying the data to determine value matches between the search entries and the data, that then provide the data matching in accordance with the applied filters and search entries, whereby the presentation of data is thus reduced by one or more filters and searches. Conducting a search with an entry of “patents that search and filter” and filtering by “data type” set to “document”, for example, reduces the presentation of data to presenting “document” data that relates to the words “patents” and “search” and “filter”.

In an embodiment, recording the history of searches is supported by posting search entries to be stored in a database in connection with the data of one or more persons. Moreover, providing a history of searches is supported by getting search entries that are stored in a database or local storage, or the like, in connection with the data of one or more persons.

In an embodiment, transmitting data to services via one or more APIs through the utilization of authentication tokens, or keys, or the like, or in a combination thereof, is supported, such that people may utilize an aggregation of services to communicate with other people and services regardless of the recipients' choice of services. People utilizing an aggregation of services may communicate with people who, for example, are utilizing an alternative service such as email.

Moreover, in an embodiment, receiving data from services via one or more APIs through the utilization of authentication tokens, or keys, or the like, or in a combination thereof, is supported, such that people may connect one or more services to receive data from other people and services regardless of the senders' choice of services. People may connect email accounts, for example, and may receive data from emails delivered to the email accounts that are connected.

In an embodiment, a categorization system is provided that is effectively a way to contextualize data. An ability to categorize data is provided via data analysis and meta-data attribution. Such data may be organized according to relevancy. Data may be labeled, for example, by values that could include “Questions”, “Information”, “Tasks, and “Events”, each of which is universally distinct and has continued importance.

In an embodiment, organizing data by relevancy is supported by automated computer processes that include meta-data analysis and/or semantic analysis, and algorithms, to determine the most relevant meta-data attribute to apply to data. Messaging data that includes text regarding a due date and an attached document with an invitation to “edit”, for example, is semantically analyzed to recognize a date and is analyzed for meta-data that regards the data as received and meta-data regarding an attachment that is also analyzed for meta-data regarding the format of a document and meta-data regarding an editing privilege, and is algorithmically quantified as a “Task”.

In an embodiment, organizing data by relevancy is supported by manual processes whereby a person makes determinations. Upon sending a message with a location and a time, for example, a person might apply an “Event” quantification to the data by providing an input that applies meta-data attributes to data.

Additionally, organizing data by relevancy through a combination of automated computer processes and manual processes is supported by meta-data analysis and/or semantic analysis, algorithms, and user-based determinations. Messaging data that includes a hypertext link, for example, is analyzed semantically for a link, and is also analyzed of meta-data for hypertext, and is algorithmically quantified as “Information”, while a person might apply a “Task” quantification to the data by providing an input that applies meta-data attributes to the data.

In an embodiment, a filing system is provided that is effectively a combination of nested filing and keyword tagging. An ability to organize data is provided via meta-data attribution of keywords and meta-data attribution of delineated keywords that provide an indicator of hierarchy.

In an embodiment, organizing data by keywords, a nesting of keywords, or a combination thereof is supported by processes of meta-data attribution via functionality for posting the attributed data. Parent keywords, such as “Invention”, for example, may exist without children keywords, and may exist in tandem with parent keywords, such as “Legal”, that have children keywords, such as “Patents”, nested within them, such is “Legal/Patents”.

In an embodiment, accessing data from a child keyword that is organized within a nesting of keywords is supported by processes of meta-data attribution via functionality for analysis of meta-data and functionality for getting the associated data. Accessing data associated with a child keyword, such as “Legal/Patents/Utility”, for example, either provides any data associated the keyword “Utility” through matching the keyword value with any meta-data keyword data that includes “Utility”, or provides data associated explicitly with the nested child keyword “Legal/Patents/Utility” through matching the delineated keyword string with meta-data delineated keyword string data.

In an embodiment, accessing data that is organized within a nesting of keywords from a parent keyword is supported by processes of meta-data attribution via functionality for analysis of meta-data and functionality for getting the associated data. Accessing data associated with a parent keyword, such as “Legal”, for example, either provides any data associated with the keyword “Legal” through matching the keyword value with any meta-data keyword data that matches “Legal”, or provides data associated with any nested keywords where the parent matches “Legal”, such as “Legal/Patents/Utility”, through matching parent keywords in delineated keyword strings of meta-data delineated keyword string data.

In an embodiment, accessing child keywords from a parent keyword is supported by analysis of meta-data and functionality for getting the associated data. Accessing a parent keyword, such as “Legal”, for example, may provide access to child keywords, such as “Legal/Patents”.

In an embodiment, providing navigation for accessing keywords is supported through meta-tag retrieval by analysis of meta-tag data and functionality for getting the associated data. Navigating hierarchical keywords, such as traversing, for example, from “Legal/Patents” to “Legal/Patents/Utility or “Legal/Patents/Utility” to “Legal/Patents”, provides either descending or ancestral traversal, respectively, by matching the delineated keyword string with meta-tag delineated keyword string data in combination with directional instructions.

In an embodiment, immediately accessing all keywords, parent keywords, and child keywords is supported through meta-tag retrieval by analysis of meta-tag data and functionality for getting the associated data. When adding a keyword to data, for example, all existing keywords may be presented for more efficient attribution.

In accordance with the teachings herein, in an embodiment, searching for or filtering through data with the ability to filter by keywords and nested keywords is supported whereby the keywords and/or nested keywords serve as the filtering qualification, that when paired with an analysis of meta-data relating data to the filtering qualification, determining value matches between the filtering qualification and the data, then provide matching data in accordance with the applied filtering qualification. Filtering data by a keyword nest, such as “Legal/Patents/Utility”, for example, and then searching by a search entry, such as “search and filter”, for example, reduces the presentation of data to presenting data that relates to the words “search” and “filter” that has meta-data with the delineated keyword string “Legal/Patents/Utility”.

In an embodiment, a centrally organized filing system is supported by a meta-data attribute shared by all data organized in accordance with the filing system. With all keywords and nested keywords sharing a centralized top layer, for example, accessing data may be more efficient.

In an embodiment, accessing data organized by various keywords in combination is supported. Data associated with different keywords, such as ‘legal’ and ‘patents/utility’, for example, may be viewable together.

In an embodiment, views associating data with time are supported that present data in accordance with time. Accessing and transmitting data continuously is provided by real-time technologies, such that transmitted data may effectively appear instantly.

In an embodiment, views that change with time are supported that present data in accordance with the perpetual flow of Time. Combining real-time technologies with animation technologies, wherein images change perpetually per a defined period, may continuously present, for example, data moving in accordance with the live movement of Time.

In an embodiment, the time in between data-events may be represented spatially. Spatially presenting the relationship between data-events and Time may be visually represented in accordance with, for example, the scheduled or recorded position of data-events in Time, or the length of data-events duration in Time, or the like, or a combination thereof.

Although the present application is described and shown in relation to particular embodiments thereof, many other variations and modifications and other uses will become apparent to those skilled in the art. Thus, various embodiments and variations are shown and described herein, and it is preferred, therefore, that the present invention be limited not by the specific disclosure herein.

What is claimed is:

1. A method, comprising:
storing on one or more processor readable media that are operatively coupled to one or more processors, at least one database comprising:
electronic user information representing a plurality of users;
electronic data information representing a plurality data respectively associated with at least one of the plurality of users; and
electronic data action information representing a plurality of data actions respectively associated with each of at least one of the plurality of data; and
electronic filtering information representing a plurality of filters respectively associated with at least one of the plurality of data;
accessing, by the one or more processors, at least some of the plurality data associated with a first user of the plurality of users;
accessing, by the one or more processors, at least some of the plurality of data actions respectively associated with the at least some of the plurality of data;
accessing, by the one or more processors, at least one of the at least some of the plurality of filters associated with the at least some of the plurality of data;
integrating, by the one or more processors, at least some of the plurality data associated with a first user of the plurality of users;
consolidating, by the one or more processors, at least some of the plurality data associated with a first user of the plurality of users;
organizing, by the one or more processors, at least some of the plurality data associated with a first user of the plurality of users;
enhancing, by the one or more processors, at least some of the plurality data associated with a first user of the plurality of users;
generating, by the one or more processors, a first presentation of data, wherein the first presentation of data includes the data associated with the first user;
providing, by the one or more processors to a first computing device operated by the first user, the first presentation of data;
receiving, by the one or more processors, first electronic data event information representing a sending or receiving of first data that are associated with at least one of the at least some of the plurality of data;
transmitting, by the one or more processors, first electronic data event information representing a sending of first data that are associated with at least one of the at least some of the plurality of users;
based at least on the first electronic data event information, reducing, by the one or more processors, at least one of the at least some of the plurality data;
modifying, by the one or more processors, the first presentation of data based at least on one of the at least some of the reducing; and
providing, by the one or more processors, to the first computing device the modified first presentation of data.

2. The method of claim 1, wherein the first data event information represents one of:
information received via an application programming interface;
information received via data entry by the first computing device;
information received via a data protocol; and
information received via an analog data source;

3. The method of claim 1, further comprising providing, by the one or more processors to the first computing device, a data transcript based at least on the first data event information.

4. The method of claim 1, wherein at least one of the accessing and the managing and the modifying and the transmitting and the integrating and the consolidating and the reducing and the organizing and the enhancing and the acting on is performed as a function of one or more of time, one or more users associated with at least one of the at least some of the plurality data, and at least one criterion received by the first computing device.

5. The method of claim 1, wherein at least one of the presenting is performed as a function of time, one or more users associated with at least one of the at least some of the plurality data, and at least one criterion received by the first computing device.

6. The method of claim 1, further comprising determining, by the one or more processors based at least on the first data event information, a respective application programming interface for receiving the first data, and accessing, by the one or more processors, the first data as function of the respective application programming interface.

7. The method of claim 1, further comprising:
accessing, by the one or more processors, at least some of the plurality data associated with a second user of the plurality of users;
accessing, by the one or more processors, at least some of the plurality of data actions respectively associated with the at least some of the plurality of data associated with the second user;
accessing, by the one or more processors, at least one of the at least some of the plurality of filters associated with the at least some of the plurality of data associated with the second user;
integrating, by the one or more processors, at least some of the plurality data associated with the second user of the plurality of users;
consolidating, by the one or more processors, at least some of the plurality data associated with the second user of the plurality of users;
organizing, by the one or more processors, at least some of the plurality data associated with the second user of the plurality of users;
enhancing, by the one or more processors, at least some of the plurality data associated with the second user of the plurality of users;
generating, by the one or more processors, a second presentation of data, wherein the second presentation of data includes the data associated with the second user;
providing, by the one or more processors to a second computing device operated by the second user, the second presentation of data;
transmitting, by the one or more processors, first electronic data event information representing a sending or receiving of first data that are associated with at least one of the at least some of the plurality of data;
based at least on the first electronic data event information, reducing, by the one or more processors, at least one of the at least some of the plurality data associated with the second user and the at least some of the plurality of data actions respectively associated with the at least some of the plurality of data associated with the second user;
modifying, by the one or more processors, the second presentation of data based on at least one of the at least some of the reducing; and
providing, by the one or more processors, to the first computing device the modified second presentation of data.

8. The method of claim 1, further comprising formatting, by the one or more processors, the first presentation of data to include selectable data actions that, when selected by the first user operating the first computing device, provide at least one tool for acting on at least one of the at least some of the plurality of respective data actions.

9. The method of claim 1, further comprising transmitting, by the one or more processors to at least one second computing device respectively operated by at least one second user, electronic data information associated with the first data event information.

10. The method of claim 1, further comprising enhancing, by the one or more processors, data actions for data on at least one of the at least some of the plurality of respective data events.

11. The method of claim 1, further comprising:
receiving, by the one or more processors, an electronic contact list that includes contact information for a plurality of individuals, wherein the electronic contact list is associated with the first user;
consolidating, by the one or more processors, contact information associated with at least the first user;
reducing, by the one or more processors, the electronic contact list based on at least one of the at least some of the plurality of filters; and
providing the reduced electronic contact list to the first computing device.

12. A system, comprising:
one or more processor readable media that are operatively coupled to one or more processors;
at least one database stored on the one or more processor readable media, the at least one database including:
electronic user information representing a plurality of users;
electronic data information representing a plurality data respectively associated with at least one of the plurality of users;
electronic data action information representing a plurality of data actions respectively associated with each of at least one of the plurality of data; and
electronic filtering information representing a plurality of filters respectively associated with at least one of the plurality of data;
wherein the one or more processors is programmed and configured to:
access at least some of the plurality data associated with a first user of the plurality of users;
access at least some of the plurality of data actions respectively associated with at least some of the plurality of data;
access at least one of the at least some of the plurality of filters associated with at least some of the plurality of data;
integrate at least some of the plurality data associated with the first user;
consolidate at least some of the plurality data associated with the first user;
organize at least some of the plurality data associated with the first user;
enhance at least some of the plurality data associated with the first user;
generate a first presentation of data, wherein the first presentation of data includes the data associated with the first user;
provide to a first computing device operated by the first user, the first presentation of data;
receive first electronic data event information representing a sending or receiving of first data that are associated with at least one of the at least some of the plurality of data;
transmit first electronic data event information representing a sending of first data that are associated with at least one of the at least some of the plurality of users;
based at least on the first electronic data event information, reducing at least one of the at least some of the plurality of data;
modify the first presentation of data based at least on one of the at least some of the reducing; and
provide to the first computing device the modified first presentation of data.

13. The system of claim 12, wherein the first data event information represents one of:
information received via an application programming interface;
information received via data entry by the first computing device;
information received via a data protocol; and
information received via an analog data source;

14. The system of claim 12, wherein the one or more processors is further programmed and configured to provide to the first computing device, a data transcript based at least on the first data event information.

15. The system of claim 12, wherein at least one of the accessing and the managing and the modifying and the transmitting and the integrating and the consolidating and the reducing and the organizing and the enhancing and the acting on is performed as a function of one or more of time, one or more users associated with at least one of the at least some of the plurality data, and at least one criterion received by the first computing device.

16. The system of claim 12, wherein at least one of the presenting is performed as a function of time, one or more users associated with at least one of the at least some of the plurality data, and at least one criterion received by the first computing device.

17. The system of claim 12, wherein the one or more processors is further programmed and configured to determine, based at least on the first data event information, a respective application programming interface for receiving the first data, and accessing, by the one or more processors, the first data as function of the respective application programming interface.

18. The system of claim 12, wherein the one or more processors is further programmed and configured to:
access at least some of the plurality data associated with a second user of the plurality of users;
access at least some of the plurality of data actions respectively associated with the at least some of the plurality of data associated with the second user;
access at least one of the at least some of the plurality of filters associated with the at least some of the plurality of data associated with the second user;
integrate at least some of the plurality data associated with the second user of the plurality of users;
consolidate at least some of the plurality data associated with the second user of the plurality of users;
organize at least some of the plurality data associated with the second user of the plurality of users;
enhance at least some of the plurality data associated with the second user of the plurality of users;
generate a second presentation of data, wherein the second presentation of data includes the data associated with the second user;
provide to a second computing device operated by the second user, the second presentation of data;
transmit at least first electronic data event information representing a sending or receiving of first data that are associated with at least one of the at least some of the plurality of data;
based at least on the first electronic data event information, reduce at least one of the at least some of the plurality data associated with the second user and the at least some of the plurality of respective data actions respectively associated with the at least some of the plurality of data associated with the second user;
modify the second presentation of data based at least on one of the at least some of the reducing; and
provide to the second computing device the modified second presentation of data.

19. The system of claim 12, wherein the one or more processors is further programmed and configured to format the first presentation of data to include selectable data actions that, when selected by the first user operating the first computing device, provide at least one tool for acting on at least one of the at least some of the plurality of respective data actions.

20. The system of claim 12, wherein the one or more processors is further programmed and configured to transmit to at least one second computing device respectively operated by at least one second user, electronic information associated with the first data event information.

21. The system of claim 12, wherein the one or more processors is further programmed and configured to enhance data actions for data on at least one of the at least some of the plurality of respective data events.

22. The system of claim 12, wherein the one or more processors is further programmed and configured to:
receive an electronic contact list that includes contact information for a plurality of individuals, wherein the electronic contact list is associated with the first user;
consolidate contact information associated with at least the first user;
reduce the electronic contact list based on at least one of the at least some of the plurality of filters; and
provide the reduced electronic contact list to the first computing device.

23. A method, comprising:
storing on one or more processor readable media that are operatively coupled to one or more processors, at least one database comprising:
electronic data information representing a plurality data; and
electronic data action information representing a plurality of data actions
respectively associated with each of at least one of the plurality of data;
accessing, by the one or more processors, at least some of the plurality data;
accessing, by the one or more processors, at least some of the plurality of data actions respectively associated with the at least some of the plurality of data;
generating, by the one or more processors, a first presentation of data, wherein the first presentation of data includes the data;
providing, by the one or more processors to a first computing device, the first presentation of data;
receiving, by the one or more processors, first electronic data event information representing a sending or receiving of first data that are associated with at least one of the at least some of the plurality of data;
based at least on the first electronic data event information, managing, by the one or more processors, at least one of the at least some of the plurality data;
modifying, by the one or more processors, the first presentation of data based at least on one of the at least some of the managing; and
providing, by the one or more processors, to the first computing device the modified first presentation of data.

24. The method of claim 23, wherein the first data event information represents one of:
information received via an application programming interface;
information received via data entry by the first computing device;
information received via a data protocol; and
information received via an analog data source;

25. The method of claim 23, further comprising providing, by the one or more processors to the first computing device, a data transcript based at least on the first data event information.

26. The method of claim 23, wherein at least one of the accessing and the managing and the modifying and the transmitting is performed as a function of one or more of time, with at least one of the at least some of the plurality data, and at least one criterion received by the first computing device.

27. The method of claim 23, wherein at least one of the presenting is performed as a function of time, with at least one of the at least some of the plurality data, and at least one criterion received by the first computing device.

28. The method of claim 23, further comprising determining, by the one or more processors based at least on the first data event information, a respective application programming interface for receiving the first data, and accessing, by the one or more processors, the first data as function of the respective application programming interface.

29. The method of claim 23, further comprising formatting, by the one or more processors, the first presentation of data to include selectable data actions that, when selected from the first computing device, provide at least one tool for acting on at least one of the at least some of the plurality of respective data actions.

30. The method of claim 23, further comprising formatting, by the one or more processors, the respective application programming interface to include a perpetually changing representation of the first data as a function of the respective application programming interface in accordance with time that, when accessed by operating the first computing device, provide visual spatial indication of at least one of the at least some of the plurality of data presented perpetually in accordance with the perpetual changing of Time.

31. A system, comprising:
one or more processor readable media that are operatively coupled to one or more processors;
at least one database stored on the one or more processor readable media, the at least one database including:
electronic data information representing a plurality data; and
electronic data action information representing a plurality of data actions respectively associated with each of at least one of the plurality of data;
wherein the one or more processors is programmed and configured to:
access at least some of the plurality data;
access at least some of the plurality of data actions respectively associated with at least some of the plurality of data;
generate a first presentation of data, wherein the first presentation of data includes the data;
provide to a first computing device, the first presentation of data;
receive first electronic data event information representing a sending or receiving of first data that are associated with at least one of the at least some of the plurality of data;
based at least on the first electronic data event information, perpetually changing at least one of the at least some of the plurality of data;
modify the first presentation of data based at least on one of the at least some of the perpetually changing; and
provide to the first computing device the modified first presentation of data.

32. The system of claim 31, wherein the first data event information represents one of:
information received via an application programming interface;
information received via data entry by the first computing device;
information received via a data protocol; and
information received via an analog data source;

33. The system of claim 31, wherein the one or more processors is further programmed and configured to provide to the first computing device, a data transcript based at least on the first data event information.

34. The system of claim 31, wherein at least one of the accessing and the managing and the modifying and the transmitting is performed as a function of one or more of time, with at least one of the at least some of the plurality data, and at least one criterion received by the first computing device.

35. The system of claim 31, wherein at least one of the presenting is performed as a function of time, with at least one of the at least some of the plurality data, and at least one criterion received by the first computing device.

36. The system of claim 31, wherein the one or more processors is further programmed and configured to determine, based at least on the first data event information, a respective application programming interface for receiving the first data, and accessing, by the one or more processors, the first data as function of the respective application programming interface.

37. The system of claim 31, wherein the one or more processors is further programmed and configured to format the first presentation of data to include selectable data actions that, when selected from the first computing device, provide at least one tool for acting on at least one of the at least some of the plurality of respective data actions.

38. The system of claim 31, wherein the one or more processors is further programmed and configured to format the respective application programming interface to include a perpetually changing representation of the first data as a function of the respective application programming interface in accordance with time that, when accessed by operating the first computing device, provide visual spatial indication of at least one of the at least some of the plurality of data presented perpetually in accordance with the perpetual changing of Time.

39. A method, comprising:
storing on one or more processor readable media that are operatively coupled to one or more processors, at least one database comprising:
electronic user information representing a plurality of users;
electronic data information representing a plurality data respectively associated with at least one of the plurality of users; and
electronic data action information representing a plurality of data actions
respectively associated with each of at least one of the plurality of data;
accessing, by the one or more processors, at least some of the plurality data associated with a first user of the plurality of users;
accessing, by the one or more processors, at least some of the plurality of data actions respectively associated with the at least some of the plurality of data;
generating, by the one or more processors, a first presentation of data, wherein the first presentation of data includes the data associated with the first user;
providing, by the one or more processors to a first computing device operated by the first user, the first presentation of data;
receiving, by the one or more processors, first electronic data event information representing a sending or receiving of first data that are associated with at least one of the at least some of the plurality of data;
transmitting, by the one or more processors, first electronic data event information representing a sending of first data that are associated with at least one of the at least some of the plurality of users;
based at least on the first electronic data event information, presenting, by the one or more processors, at least one of the at least some of the plurality data;

40. The method of claim 39, wherein the first data event information represents one of:
information received via an application programming interface;
information received via data entry by the first computing device;
information received via a data protocol; and
information received via an analog data source;

41. The method of claim 39, further comprising providing, by the one or more processors to the first computing device, a data transcript based at least on the first data event information.

42. The method of claim 39, wherein at least one of the accessing and the managing and the modifying and the transmitting is performed as a function of one or more of time, one or more users associated with at least one of the at least some of the plurality data, and at least one criterion received by the first computing device.

43. The method of claim 39, wherein at least one of the presenting is performed as a function of time, one or more users associated with at least one of the at least some of the plurality data, and at least one criterion received by the first computing device.

44. The method of claim 39, further comprising determining, by the one or more processors based at least on the first data event information, a respective application programming interface for receiving the first data, and accessing, by the one or more processors, the first data as function of the respective application programming interface.

45. The method of claim 39, further comprising:
accessing, by the one or more processors, at least some of the plurality data associated with a second user of the plurality of users;
accessing, by the one or more processors, at least some of the plurality of data actions respectively associated with the at least some of the plurality of data associated with the second user;
generating, by the one or more processors, a second presentation of data, wherein the second presentation of data includes the data associated with the second user;
providing, by the one or more processors to a second computing device operated by the second user, the second presentation of data;
transmitting, by the one or more processors, second electronic data event information representing a sending or receiving of second data that are associated with at least one of the at least some of the plurality of data;
based at least on the first electronic data event information, perpetually changing, by the one or more processors, at least one of the at least some of the plurality data associated with the second user and the at least some of the plurality of data actions respectively associated with the at least some of the plurality of data associated with the second user;
modifying, by the one or more processors, the second presentation of data based at least on one of the at least some of the perpetually changing; and
providing, by the one or more processors, to the first computing device the modified second presentation of data.

46. The method of claim 39, further comprising formatting, by the one or more processors, the first presentation of data to include selectable data actions that, when selected by the first user operating the first computing device, provide at least one tool for acting on at least one of the at least some of the plurality of respective data actions.

47. The method of claim 39, further comprising transmitting, by the one or more processors to at least one second computing device respectively operated by at least one second user, electronic data information associated with the first data event information.

48. The method of claim 39, further comprising formatting, by the one or more processors, the respective application programming interface to include a perpetually changing representation of the first data as a function of the respective application programming interface in accordance with time that, when accessed by operating the first computing device, provide visual spatial indication of at least one of the at least some of the plurality of data associated with at least the first user presented perpetually in accordance with the perpetual changing of Time.

49. A system, comprising:
one or more processor readable media that are operatively coupled to one or more processors;
at least one database stored on the one or more processor readable media, the at least one database including:
electronic user information representing a plurality of users;
electronic data information representing a plurality data respectively associated with at least one of the plurality of users; and
electronic data action information representing a plurality of data actions respectively associated with each of at least one of the plurality of data;
wherein the one or more processors is programmed and configured to:
access at least some of the plurality data associated with a first user of the plurality of users;
access at least some of the plurality of data actions respectively associated with at least some of the plurality of data;
generate a first presentation of data, wherein the first presentation of data includes the data associated with the first user;
provide to a first computing device operated by the first user, the first presentation of data;
receive first electronic data event information representing a sending or receiving of first data that are associated with at least one of the at least some of the plurality of data;
transmit first electronic data event information representing a sending of first data that are associated with at least one of the at least some of the plurality of users;
based at least on the first electronic data event information, perpetually changing at least one of the at least some of the plurality of data;
modify the first presentation of data based at least on one of the at least some of the perpetually changing; and
provide to the first computing device the modified first presentation of data.

50. The system of claim 49, wherein the first data event information represents one of:
information received via an application programming interface;
information received via data entry by the first computing device;
information received via a data protocol; and
information received via an analog data source;

51. The system of claim 49, wherein the one or more processors is further programmed and configured to provide to the first computing device, a data transcript based at least on the first data event information.

52. The system of claim 49, wherein at least one of the accessing and the managing and the modifying and the transmitting is performed as a function of one or more of time, one or more users associated with at least one of the at least some of the plurality data, and at least one criterion received by the first computing device.

53. The system of claim 49, wherein at least one of the presenting is performed as a function of time, one or more users associated with at least one of the at least some of the plurality data, and at least one criterion received by the first computing device.

54. The system of claim 49, wherein the one or more processors is further programmed and configured to determine, based at least on the first data event information, a respective application programming interface for receiving the first data, and accessing, by the one or more processors, the first data as function of the respective application programming interface.

55. The system of claim 49, wherein the one or more processors is further programmed and configured to:
access at least some of the plurality data associated with a second user of the plurality of users;
access at least some of the plurality of data actions respectively associated with the at least some of the plurality of data associated with the second user;
access at least one of the at least some of the plurality of filters associated with the at least some of the plurality of data associated with the second user;
generate a second presentation of data, wherein the second presentation of data includes the data associated with the second user;
provide to a second computing device operated by the second user, the second presentation of data;
transmit first electronic data event information representing a sending or receiving of first data that are associated with at least one of the at least some of the plurality of data;
based at least on the first electronic data event information, perpetually changing at least one of the at least some of the plurality data associated with the second user and the at least some of the plurality of respective data actions respectively associated with the at least some of the plurality of data associated with the second user;
modify the second presentation of data based at least on one of the at least some of the perpetually changing; and
provide to the second computing device the modified second presentation of data.

56. The system of claim 49, wherein the one or more processors is further programmed and configured to format the first presentation of data to include selectable data actions that, when selected by the first user operating the first computing device, provide at least one tool for acting on at least one of the at least some of the plurality of respective data actions.

57. The system of claim 49, wherein the one or more processors is further programmed and configured to transmit to at least one second computing device respectively operated by at least one second user, electronic information associated with the first data event information.

58. The system of claim 49, wherein the one or more processors is further programmed and configured to format the respective application programming interface to include a perpetually changing representation of the first data as a function of the respective application programming interface in accordance with time that, when accessed by operating the first computing device, provide visual spatial indication of at least one of the at least some of the plurality of data, associated with at least the first user, presented perpetually in accordance with the perpetual changing of Time.
